(19) United States
(12) Patent Application Publication
(10) Pub. No.: US 2003/0165625 A1
(43) Pub. Date: Sep. 4, 2003

(54) Method of making a nanoporous film

(76) Inventors: Ying Hung So, Midland, MI (US); Q. Jason Niu, Midland, MI (US); Paul H. Townsend III, Midland, MI (US); Steve J. Martin, Midland, MI (US); Thomas H. Kalantar, Midland, MI (US); James Peter Godschalx, Midland, MI (US); Kennethus J. Bruza, Alma, MI (US); Kevin J. Bouck, Midland, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/077,646

(22) Filed: Feb. 15, 2002

(51) Int. Cl. B05D 3/02

(52) U.S. Cl. 427/385.5

(57) ABSTRACT

Applicants found that selection of reactive nanoparticles as poragens when combined with monomeric precusors to organic, particularly polyarylene or polyarylene ether, matrix materials are effective in obtaining very small pore sizes.

This invention was made with United States Government support under Cooperative Agreement No. 70NANB8H4013 awarded by NIST. The United States Government has certain rights in the invention.

### FIELD OF THE INVENTION

This invention relates to a method of making a nanoporous film particularly for use in making integrated circuit devices having nanoporous organic interlayer dielectrics.

### BACKGROUND OF THE INVENTION

As feature sizes in integrated circuits are decreasing an increasing need has developed for better dielectric materials to serve as insulators between metal lines in the circuit. In fact, the demand for low dielectric constant materials has reached a point where known solid materials will not be sufficient to meet the demand. Thus, a variety of methods for putting pores into the dielectric materials have been devised.

According to one class of approach, a silicon based precursor material is mixed with a pore generating material—also referred to as a poragen (usually a material that thermally decomposes at a temperature above the cure temperature of the silicon based material), the mixture is coated onto the substrate, the silicon precursor material is reacted or cured to form a matrix material and the pore generating material is removed by heating. See e.g. U.S. Pat. No. 5,700,844; U.S. Pat. No. 5,883,219; and U.S. Pat. No. 6,143,643.

According to another class of approach an organic matrix material is used instead of the silicon based material. Some of the organic matrix materials that have been taught include polyarylenes, polyarylene ethers, and polyimides. Some subsets of this approach are the methods taught in U.S. Pat. No. 6,280,794 (which uses abietic acid or rosin as the sacrificial compound) and U.S. Pat. No. 6,172,128, U.S. Pat. No. 6,313,185, and U.S. Pat. No. 6,156,812 (which use as the thermally labile group organic groups such as ethylene glycol-polycaprolactone that are covalently bonded to a polymeric strand that will, when cured, form the matrix material).

U.S. Pat. No. 6,093,636 and U.S. Pat. No. 2001/0040294 use organic polymeric matrix materials. In these systems a crosslinkable polymeric precursor is blended with the poragen. The poragen may be a variety of materials including linear, branched, and crosslinked polymers and copolymers and crosslinked polymeric nanoparticles with reactive surface functionality. Similarly, in Polymeric Materials: Science & Engineering 2001, 85,502, Xu et al. teach blending such nanoparticles with polyimides.

Earlier work done by Hedrick et al. suggested forming a block copolymer with one of the polymeric blocks being thermally labile See e.g. U.S. Pat. No. 5,776,990.

Bruza et al. also taught a variety of methods for making porous organic films. See WO00/31183, Bruza et al. mentioned use of a variety of poragens including linear, branched polymers and copolymers as well as nanoparticulate type poragens. The poragens were taught to be reactive or non-reactive. Bruza also taught that the poragens could be combined with the matrix materials at any stage before cure of the matrix.

### SUMMARY OF THE INVENTION

While many of the above methods are effective in making porous films, Applicants discovered by using the above methods it was nevertheless very difficult if not impossible to reliably make porous films with very small pores, especially closed cell pores, in an organic matrix. Specifically, Applicants found reliable obtention of small pores difficult when poragens other than those that are discrete particles are used. Moreover, contrary to the trend of the teachings which indicate that in organic systems it is desirable to add the poragen to a crosslinkable polymer, Applicants found that this led to large pore sizes even when a small nanoparticle-type poragen was used.

As a solution to these problems, Applicants found that selection of reactive nanoparticles when combined with monomeric precusors to organic matrix materials, particularly polyarylene or polyarylene ether matrix materials are effective in obtaining very small pore sizes.

Thus, according to a first embodiment this invention is a method comprising

providing monomeric precursors to an organic polymeric matrix material,

partially polymerizing the precursors in the presence of nanoparticles, which are characterized in that the particles have reactive functionality and the particles have an average diameter of less than 30 nm, to form a curable oligomeric mixture wherein the nanoparticles are grafted with the oligomers,

coating the oligomeric mixture onto a substrate, and

heating the mixture to crosslink the oligomers and decompose the nanoparticles to form pores having an average diameter of less than 30 nm.

### DETAILED DESCRIPTION OF THE INVENTION

### The Monomeric Precursors

The monomeric precursors may be any monomers that react to form an organic, crosslinked polymeric matrix material. Preferably, the matrix material is a polyarylene or polyarylene ether. See e.g. U.S. Pat. No. 5,115,082; 5,155,175; 5,179,188; 5,874,516; 5,965,679; 6,121,495; 6,172,128; 6,313,185; and 6,156,812 and in PCT WO 91/09081; WO 97/01593 all of which are incorporated herein by reference for suitable matrix polyarylenes and their monomeric precursors. One preferred example of suitable monomers are of the formula

(R—C≡C)ₙAr—L[Ar(C≡C—R)ₘ]_{q}

wherein each Ar is an aromatic group or inertly-substituted aromatic group; each R is independently hydrogen, an alkyl, aryl or inertly-substituted alkyl or aryl group; L is a covalent bond or a group which links one Ar to at least one other Ar; n and m are integers of at least 2; q is an integer of at least 1 at least two of the ethynylic groups on one of the aromatic rings are ortho to one another. Preferably, at least two of the ethynylic groups on two of the aromatic rings are ortho to one another. Other preferred monomers include compounds that react, at least in part, via Diels Alder reaction. Thus, multifunctional compounds having conjugated diene groups and dienophile groups are useful. For example, the following monomers could be used

biscyclopentadienone of the formula (II):

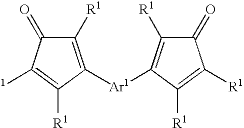

with polyfunctional acetylene of the formula (III):

[R²≡]_{y}Ar³

and, optionally, a diacetylene of the formula:

R²≡Ar²≡R²

wherein R¹ and R² are independently H or an unsubstituted or inertly-substituted aromatic moiety and Ar¹, Ar² and Ar³ are independently an unsubstituted aromatic moiety, or inertly-substituted aromatic moiety, and y is an integer of three or more. Other useful monomers may include those having both the diene and dienophile groups on a single monomer such as:

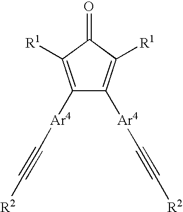

wherein R¹, R², and Ar⁴ are as defined previously. Monomers comprising at least two dienophile groups and at least two ring structures which ring structures are characterized by the presence of two conjugated carbon-to-carbon double bonds and the presence of a leaving group L, wherein L is characterized that when the ring structure reacts with a dienophile in the presence of heat or other energy sources, L is removed to form an aromatic ring structure are also desireable. See e.g. copending application ______ having attorney docket no. 61992, incorporated herein by reference.

Particularly, preferred groups of these monomers may be represented by the formula Z-X-Z or the formula Z-X-Z′-X-Z wherein

Z is selected from

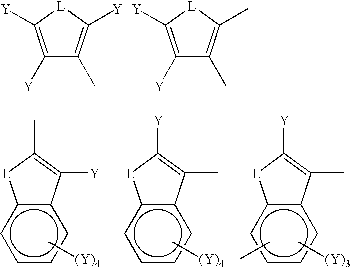

Z′ is selected from

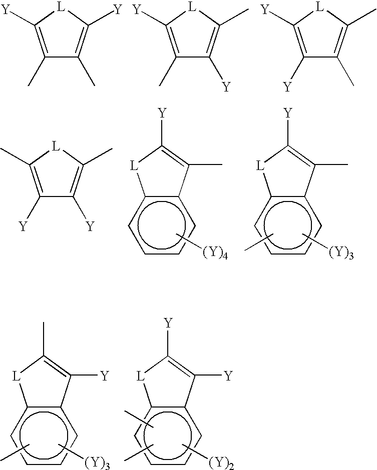

L is —O—, —S—, —N═N—, —(CO)—, —(SO₂)—, or —O(CO)—;

Y is independently in each occurrence hydrogen, an unsubstituted or inertly substituted aromatic group, an unsubstituted or inertly substituted alkyl group or

—W—C≡C—V

X is an unsubstituted or inertly substituted aromatic group or is

—W—C≡C—W—

and

W is an unsubstituted or inertly substituted aromatic group, and V is hydrogen, an unsubstituted or inertly substituted aromatic group, or an unsubstituted or inertly substituted alkyl group;

provided that at least two of the X and Y groups comprise an acetylene group. By inertly-substituted as used herein, applicants mean a substituent group which does not interfere with the polymerization reaction of the monomer.

One preferred example of the latter multifunctional monomers may be represented by the formula (I):

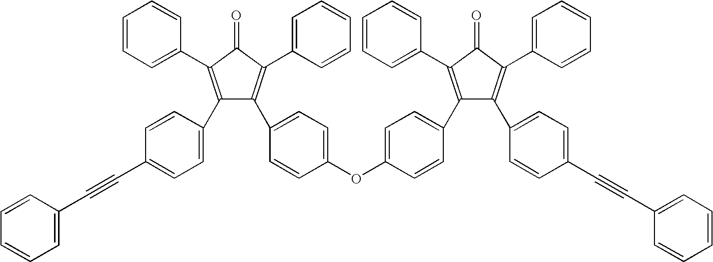

The Nanoparticles

The nanoparticles may be any particle that based on its chemical structure maintains its shape whether in the presence of a solvent or not. By maintains its shape is meant that the particle does not unwind or elongate upon interaction with the solvents or matrix materials but rather forms domains within that matrix material of a size similar to that of the initial nanoparticle. It may swell with matrix materials or solvents as they penetrate into the nanoparticle, but the nanoparticle will nevertheless retain its shape. Examples of such nanoparticles include, star polymers, dendrimers and hyperbranched polymers (e.g. polyamidoamine (PAMAM), dendrimers as described by Tomalia, et al., Polymer J. (Tokyo), Vol. 17, 117 (1985), which teachings are incorporated herein by reference; polypropylenimine polyamine (DAB-Am) dendrimers available from DSM Corporation; Frechet type polyethereal dendrimers (described by Frechet, et al., J. Am. Chem. Soc., Vol. 112, 7638 (1990), Vol. 113, 4252(1991)); Percec type liquid crystal monodendrons, dendronized polymers and their self-assembled macromolecules (described by Percec, et al., Nature, Vol. 391, 161(1998), J. Am. Chem. Soc., Vol. 119, 1539(1997)); hyperbranched polymer systems such as Boltorm H series dendritic polyesters (commercially available from Perstorp AB)). More preferably the nanoparticles should be crosslinked polymeric nanoparticles. The particles preferably have a shape approximating a Newtonian object (e.g. a sphere) although misshapen (e.g. slightly oblong or elliptical, bumpy, etc.) particles may be used as well. For polyarylene and polyarylene ether matrix materials, styrene based nanoparticles are preferred. However, the nanoparticle may comprise other monomers such as 4-tert-butylstyrene, divinylbenzene, 1,3-diisopropenylbenzene, methyl acrylate, butyl acrylate, hydroxypropyl acrylate, 4-hydroxybutyl acrylate, and the like.

The nanoparticles should be selected such that they thermally decompose, preferably in the absence of air, at a temperature above suitable polymerization temperatures for the matrix material but below the glass transition temperature for the cured matrix materials. Particularly, it is critical that the matrix material has sufficiently set up or cured prior to decomposition of the nanoparticle so as to avoid cell collapse.

These nanoparticles comprise reactive functionality or reactive functional groups. By reactive functionality or reactive functional groups is meant a chemical species which is characterized in that it reacts with the matrix precursor during the partial polymerization of the monomeric precursors. Examples of such reactive functionality include ethylenic unsaturated groups, hydroxyl, acetylene, amine, phenylethynyl, cyclopentadienone, α,β-unsaturated esters, α,β-unsaturated ketones, maleimides, aromatic and aliphatic nitriles, coumalic esters, 2-furanoic esters, propargyl ethers and esters, propynoic esters and ketones, etc. that are available to react the nanoparticles with the matrix materials during the partial polymerization of the monomers. The functional groups may be residual groups that remain after synthesis or manufacture of the particle or may be added by subsequent additional reaction steps.

The most preferred nanoparticles are crosslinked polystyrene based nanoparticles. These nanoparticles may be made by emulsion polymerization of styrene monomers (e.g. styrene, alpha methyl styrene, etc.) with a comonomer having at least two ethylenically unsaturated groups capable of free radical polymerization (e.g. divinylbenzene and 1,3-diisopropenylbenzene). Particularly, preferred embodiments of such crosslinked nanoparticles are those taught in copending application Ser. No. ______ (attorney docket no. 61599). These most preferred nanoparticles will have some residual ethylenic unsaturation. Without wishing to be bound by theory, Applicants speculate that the ethylenic unsaturation assists in reacting the nanoparticles to the matrix materials during the B-staging.

However, with regard to the most preferred nanoparticles with matrices that are formed by Diels-Alder reaction, Applicants were surprised to find that no additional functional group beyond the minimal residual ethylenic unsaturation is needed to form small, regular pores.

The Partial Polymerization (i.e. B-Staging)

A critical and surprising discovery made by Applicants was that to reliably make small pores it was essential to combine the poragen with the monomeric matrix precursor prior to reaction of the monomeric matrix precursor followed by partially polymerizing the monomeric matrix precursor in the presence of the poragen.

Preferably, the nanoparticles and the monomers are combined in a suitable solvent. Suitable solvents include mesitylene, gamma butyrolactone, dipropyleneglycol methylether acetate (DPMA), etc.

The exact reaction conditions (i.e. temperature, time, etc.) will depend upon the matrix material selected. For most polyarylene and polyarylene ether materials, particularly those made by Diels-Alder reaction, B-staging may occur at temperatures from 150 to 300° C. for 1 to 50 hours. It is advised to carefully monitor the composition in order to stop the reaction prior to the composition reaching its gel point.

As previously noted, during the B-staging the poragens will become grafted with the oligomers being formed. The preferred level of grafting may depend upon both the poragen used and the matrix formulation. Graft ratios (i.e. weight of matrix which is grafted to poragen divided by weight of poragen) of at least 0.01 are most preferred. Such graft ratios are reasonably determined by SEC or GPC analysis of the particle molecular weight. For precursor monomers of formulas II and III used together with a crosslinked polystyrene based nanoparticle the graft ratios are preferably less than about 0.3, more preferably less than 0.25 depending to some extent upon the ratio of the monomers. For multifunctional monomers having the diene and dienophiles on the same molecule, e.g. monomers of the formula I, used with crosslinked polystyrene based nanoparticles the graft ratio is preferably less than 0.85, more preferably less than 0.4 and preferably is greater than 0.1.

The Coating

The B-staged materials are coated onto the desired substrate. In the preferred use of this material, it is expected that the substrate will comprise electrical interconnects and/or that electrical interconnects will be formed in the coated article by standard subtractive or damascene manufacturing techniques for manufacture of integrated circuit articles.

Coating may be performed by any known technique, but solution coating techniques such as spin coating are preferred.

The Cure and Burnout

After coating, the film is heated to remove any residual solvent. The film is also heated to crosslink the matrix material past its gel point. In addition, the film is heated to crosslink the matrix to vitrification and to thermally degrade the poragen. These heating steps may occur in a single heating pass or may occur in separate heating steps. To remove the solvent a temperature in the range of 50-200° C. is typically preferred. Preferably, the matrix is crosslinked past its gel point by heating to a temperature in the range of 200-400° C., more preferably 250° C. to 375° C. for up to 5 hours, more preferably up to 1 hour, most preferably 1 to 5 minutes. Preferably, crosslinking to vitrification occurs by heating to a temperature in the range of 250-450° C., more preferably 300 to 400° C. for up to 5 hours, more preferably up to 1 hour most preferably 1 to 5 minutes. Preferably, thermal degradation of the poragen occurs by heating to a temperature in the range of 250-450° C., preferably 350 to 450° C. for up to 5 hours, more preferably up to 1 hour, most preferable 1 to 30 minutes.

### EXAMPLES

### Example 1

1,3,5-Tris(phenylethynyl)benzene (7.56 g), 4,4′-bis(2,4,5-triphenylcyclopentadien-3-one) (15.64 g), gamma-butyrolactone (58 g) and crosslinked particles made by emulsion polymerization of divinylbenzene with styrene and having an average diameter of about 16 nm (4.65 g) were heated at 200° C. for 20 hours. The mixture was cooled to 130° C. and mesitylene (25 g) was added. The composition had a graft ratio of about 0.0124. The mixture was spin-coated on a wafer and then heated in a nitrogen purged oven from 25° C. to 430 at 7° C./min. The wafer was cured at 430° C. for 40 minutes. The film had a refractive index (RI) of 1.562 and light scattering index (LSI) of 45. TEM showed uniformly distributed pores ranging from 7 to 50 nm with estimated mean pore size of 25 nm.

### Example 2

1,3,5-Tris(phenylethynyl)benzene (3.78 g), 4,4′-bis(2,4,5-triphenylcyclopentadien-3-one) (7.82 g), gamma butyrolactone (29 g) crosslinked particles made by emulsion polymerization of divinylbenzene with styrene and having an average diameter of about 16 nm (2.28 g) were heated at 200° C. for 40 hours. The composition displayed a graft ratio of about 0.0164. The mixture was cooled to 130° C. and mesitylene (15 g) was added. The mixture was spin-coated on a wafer and then heated in a nitrogen purged oven from 25° C. to 430° C. at 7° C./min. The wafer was cured at 430° C. for 40 minutes. The film had a refractive index (RI) of 1.571 and LSI of 40.7. TEM showed uniformly distributed pores ranging from 4 to 38 nm with estimated mean pore size of 18 nm.

### Example 3

Mixture of 3,4-bis(4-phenylethynyl-phenyl)-2,5-diphenylcyclopenta-2,4-dienone (4.0 g, disclosed in U.S. Pat. No. 5,965,679), gamma-butyrolactone (9.3 g), and crosslinked particles made by emulsion polymerization of divinylbenzene with styrene and having an average diameter of about 26 nm (1.72 g) was heated at 200° C. for 28 hours. The mixture was cooled to 130° C. and cyclohexanone (15 g) was added. The mixture was spin-coated on a wafer and then heated in a nitrogen purged oven from 25° C. to 430 at 7° C./min. The wafer was cured at 430° C. for 40 minutes. The film had a refractive index (RI) of 1.45 and LSI of 26.5. TEM showed uniformly distributed pores ranging from 8 to 47 nm with estimated mean pore size of 25 nm.

### Comparative Examples 1 and 2

Crosslinked particles made by emulsion polymerization of divinylbenzene with styrene and having an average diameter of about 18 nm (4 g) was added to 100 g of a partially polymerized reaction product (20 wt % oligomer in solution) of a 1:1 molar ratio of 1,3,5-tris(phenylethynyl)benzene:4,4′-bis(2,4,5-triphenylcyclopentadien-3-one) in cyclohexanone and gamma-butyrolactone solvents. The partially polymerized reaction product had a weight average molecular weight of about 27,000 g/mol and a number average molecular weight of about 9,000 g/mol. Cyclohexanone (43 g) was added to lower the oligomer content to 14% by weight. A wafer was spin-coated at 2000 rpm for 20 seconds followed by hot plate bake for 2 minutes at 150° C. The wafer was ramped at 7° C./min to 430° C. and was held at that temperature for 40 minutes. TEM showed domains larger than 200 nm. The above experiment was repeated by adding 6 g of crosslinked polystyrene nanoparticle to 100 g of 30 wt % oligomer with weight average molecular weight of 10,000 g/mol and number average molecular weight of 4,600 g/mol. TEM also showed domains larger than 200 nm.

### Example 4

Preparation of Porous Matrix from Monomer of Formula I and Star Polymers

A. Preparation of Reactive Star Polymer

A 2.5 L glass polymerization reactor, which had been washed with hot cyclohexane and dried under vacuum, was charged with 2 L of cyclohexane. The reactor was heated to 50° C. and 25.2 mL (10.86 mmoles) of 0.43 M sec-BuLi was added followed by 49.74 g of styrene and 74 mL of THF. The dark orange solution was stirred for 15 min. The polymerization was sampled (sample A) and 5.39 g (41.41 mmoles, 3.8 eq) of para-divinylbenzene, contained in cyclohexane, was added to give a very dark red solution. After 30 min, 47.5 g of styrene was added to give a dark orange solution. After 15 min, the reactor was sampled (sample B) and 4.8 g of ethylene oxide was added to give a colorless viscous solution. After 1 hour, 5.44 g (22.60 mmoles, 2.1 eq) of 4-(phenylethynyl)benzoyl chloride contained in tetrahydrofuran was added. After an additional hour, the reactor was cooled and the contents were removed. An aliquot (sample C) of the final star was isolated by precipitation into MeOH. Results of the GPC analysis of the samples were as follows (data is relative to polystyrene standards except where labelled as absolute):

| Sample | M_{w} | Mₙ | M_{w}/Mₙ |
|---|---|---|---|
| A | 4,700 | 4,100 | 1.15 |
| B | 77,400 | 69,400 | 1.12 |
| C | 96,000 | 77,400 | 1.24 |
| C (Absolute) | 345,000 | 241,000 | 1.43 |

Ultraviolet analysis showed the star contained an average of 2.25 wt % diphenylacetylene, or 22.6 diphenylacetylene units per star.

B. B-Staging of Reactive Star Polymer with Monomer Formula I

To a Schlenk tube was added 1.2857 grams of a reactive polystyrene star polymer from A above (absolute Mn=241,000, absolute Mw=345,000, average number of diphenylacetylene moieties per star=23) and gamma-butyrolactone (8.75 g). The tube was connected to a static nitrogen source and immersed in an oil bath heated to 45° C. The mixture was stirred overnight. To the tube was then added monomer I (3.00 g). The mixture was stirred and degassed by the application of numerous vacuum/nitrogen cycles. The tube was left under a static nitrogen pressure and then the oil bath was heated to 200° C. and held there for 8.5 hours. The tube was removed from the oil bath and allowed to cool. The mixture was diluted with cyclohexanone (8.3928 g). The mixture was analyzed by gel permeation chromatography indicating a Mn=3545 and a Mw=35,274 relative to a polystyrene standard.

C. Preparation of Porous Matrix from Monomer I and Reactive Star Polymer

The mixture from B above was spun coat onto a 4″ silicon wafer, hot plate baked at 150° C. for 2 minutes to remove solvent, then heated to 430° C. at 7° C/min and held at 430° C. for 40 minutes in a nitrogen purged oven. The resultant porous film had a refractive index of 1.47 (compared to 1.64 for the fully dense polymer) and a dielectric constant of 2.13. Evaluation of the resultant film by transmission electron microscopy (TEM) indicated an average pore diameter of 18 nm

What is claimed is:

1. A method comprising
providing monomeric precursors to an organic polymeric matrix material,
partially polymerizing the precursors in the presence of nanoparticles, which have a weight average diameter of less than 30 nm and which have a thermal decomposition temperature, to form a curable oligomeric mixture wherein the nanoparticles are grafted with the oligomers,
coating the oligomeric mixture onto a substrate, and
heating the mixture thereby to crosslinking the oligomers and decomposing the nanoparticles to form pores having an average diameter of less than 30 nm.

2. The method of claim 1 wherein the polymeric matrix material is a polyarylene.

3. The method of claim 2 wherein the nanoparticle comprises polystyrene.

4. The method of claim 1 wherein the nanoparticle is a crosslinked polymeric particle.

5. The method of claim 3 wherein the nanoparticle is a crosslinked polymeric particle.

6. The method of claim 2 wherein the monomers are selected from multifunctional compounds comprising conjugated diene functional groups and dienophile functional groups wherein at least some of the compounds have three or more of such functional groups.

7. The method of claim 2 wherein the monomers are selected from compounds comprising cyclopentadienone and aromatic acetylene groups.

8. The method of claim 6 wherein at least some of the monomers comprise conjugated dienes and dienophiles on the same monomer.

9. The method of claim 5 wherein the crosslinked polymeric particle comprises residual ethylenic groups available for grafting with the monomers.

10. The method of claim 9 wherein the particle is the reaction product of styrene, 4-tert-butylstyrene, hydroxypropyl acrylate, and at least one crosslinking monomer selected from divinylbenzene and 1,3-diisopropenylbenzene.

11. The method of claim 1 wherein the particle is a star polymer.

12. The method of claim 1 wherein the particle is a dendrimer.

13. The method of claim 9 wherein the graft ratio is in the range of 0.01 to 0.8.
